(19) United States
(12) Patent Application Publication
(10) Pub. No.: US 2026/0032449 A1
(43) Pub. Date: Jan. 29, 2026

(54) METHODS AND APPARATUS FOR USER-AWARE TRUSTWORTHY SUBSCRIPTION-BASED SERVICE INTERACTION IN WIRELESS NETWORKS

(71) Applicant: InterDigital Patent Holdings, Inc., Wilmington, DE (US)

(72) Inventors: Chonggang WANG, Princeton, NJ (US); Xu LI, Plainsboro, NJ (US); Robert GAZDA, Spring City, PA (US); Michael STARSINIC, Newtown, PA (US); Samir FERDI, Kirkland (CA); Ulises OLVERA-HERNANDEZ, Saint-Lazare (CA)

(73) Assignee: InterDigital Patent Holdings, Inc., Wilmington, DE (US)

(21) Appl. No.: 18/781,255

(22) Filed: Jul. 23, 2024

(51) Int. Cl. H04W 12/60; H04W 12/062

(52) U.S. Cl. CPC H04W 12/66; H04W 12/062

(57) ABSTRACT

A function entity service producer (FESP) hosts a service function and receives a subscription request message from a function entity service consumer (FESC) including an indication of requested services and an indication of a condition that the service function is to apply when determining whether to send a service notification pursuant to the subscription. The FESP receives the FESC's a trust index from a trust management function (TMF). The trust index is at least one of a trust index of the FESC or of a user of the FESC The FESP determines to authenticate the subscription request if the trust index is greater than a threshold. The FESP receives an updated trust index of the FESC from the TMF when the condition is met and sends the service notification to the FESC when the updated trust index of the FESC is greater than the threshold.

### SUMMARY

A function entity service producer (FESP) hosts a service function and receives a subscription request message from a function entity service consumer (FESC) including an indication of requested services and an indication of a condition that the service function is to apply when determining whether to send a service notification pursuant to the subscription. The FESP receives a trust index from a trust management function (TMF). The trust index is at least one of a trust index of the FESC or of a user of the FESC. The FESP determines to authenticate the subscription request if the trust index is greater than a threshold. The FESP receives an updated trust index of the FESC from the TMF when the condition is met and sends the service notification to the FESC when the updated trust index of the FESC is greater than the threshold.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram showing examples of dynamic service access from a user;

FIG. 3 is a system diagram of an example dynamic trust-based authentication architecture for subscribe/notify-based service interaction;

FIG. 4 is a signal diagram showing an example trust-based authentication for subscribe/notify-based service interaction using continuous authentication and authorization of an FESC;

FIG. 5 is a signal diagram showing an example trust-based authentication for subscribe/notify-based service interaction using continuous authentication and authorization of an FESP;

FIG. 6 is a signal diagram showing an example trust-based authentication for subscribe/notify-based service interaction using an SCP to perform continuous authentication and authorization of an FESP;

FIG. 7 is a signal diagram showing an example of dynamic trust-based authentication for subscribe/notify-based service interaction using an ETSI PDL Service Platform; and

FIG. 8 is a signal diagram showing an example of PDL service interactions based on dynamic trust-based authentication and subscribe/notify using an ETSI PDL Service Platform.

### DETAILED DESCRIPTION

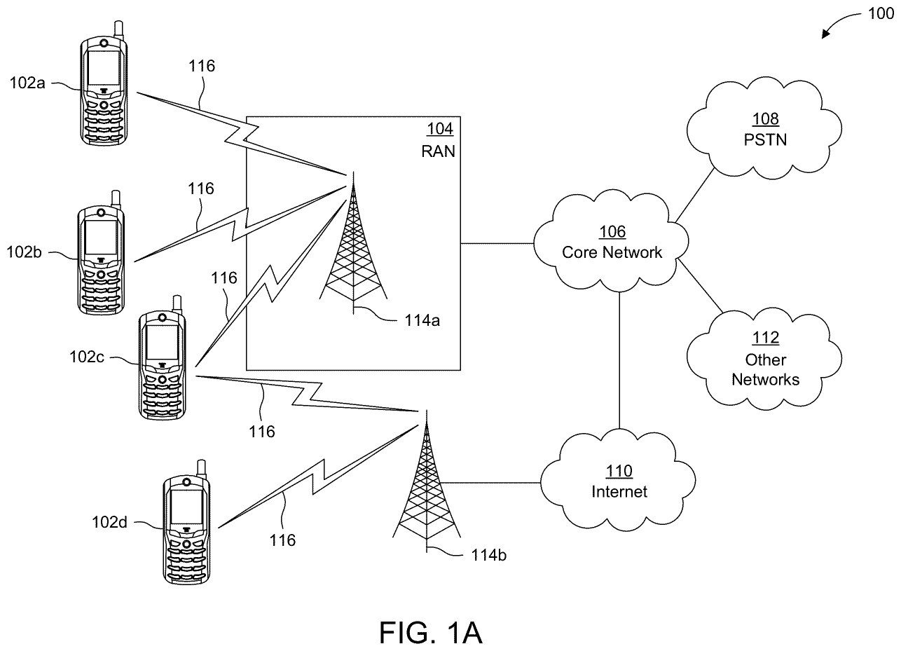

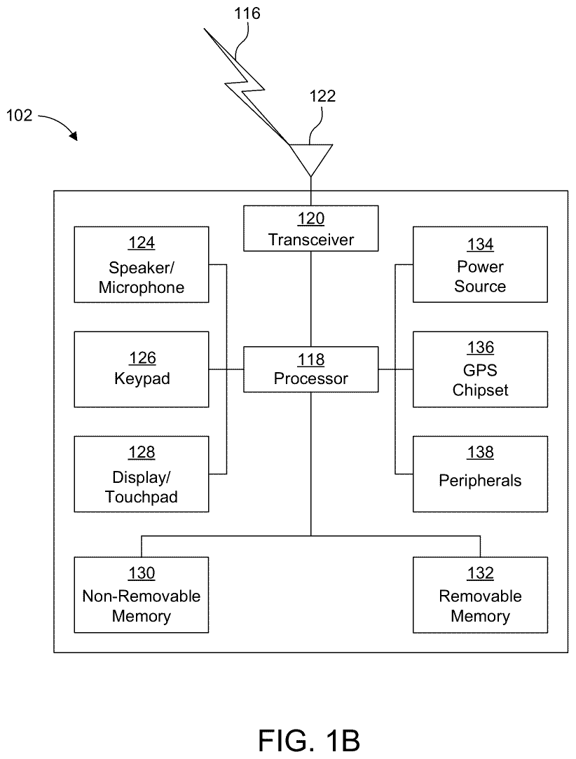

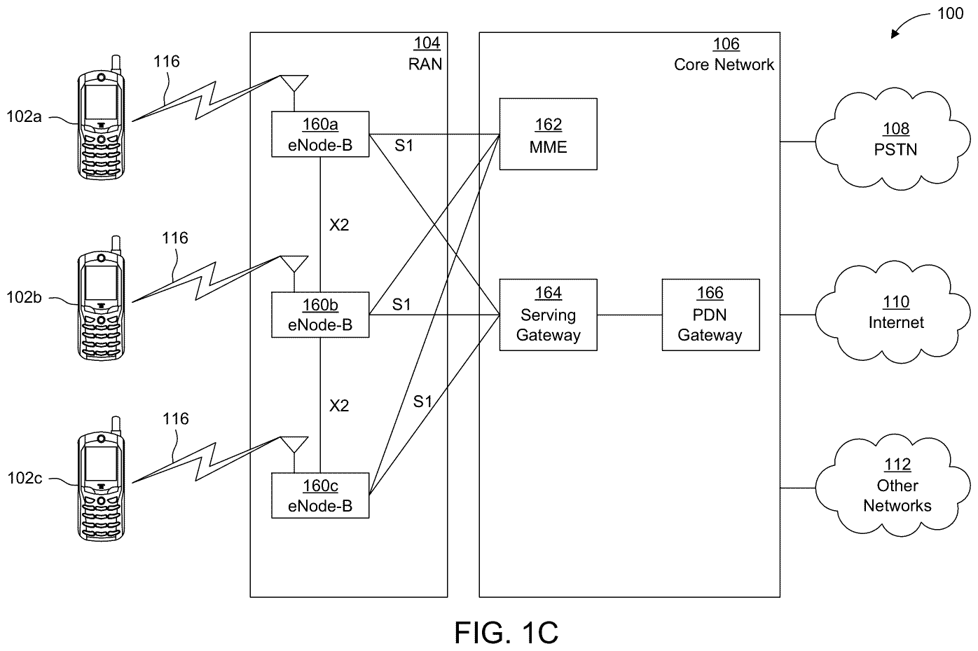

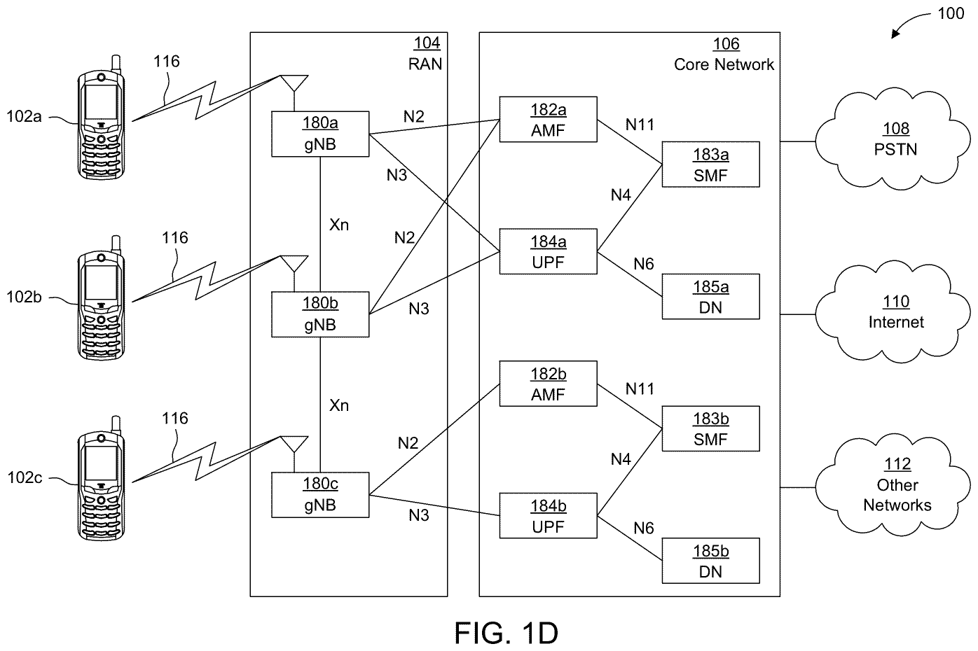

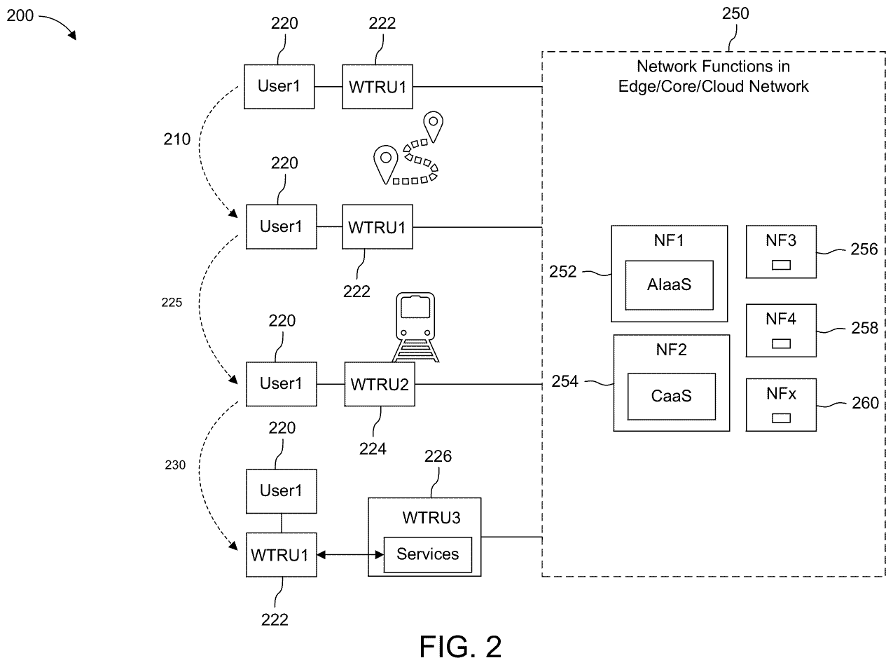

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The 5G system (5GS) architecture includes one or more WTRUs, a Radio Access Network (RAN), and a Core Network (CN). The 5GS is service-centric or service-based. The 5G Core Network (5GC) has a Service-Based Architecture (SBA) and contains a variety of Network Functions (NFs), which work together to fulfill and provide needed services to the RAN, WTRUs, and Application Servers/Service Providers. The WTRU interacts with the RAN/5GC via Non-Access Stratum (NAS) and Access Stratum (AS) signaling.

An NF can access other NFs in request/response mode or subscription/notification mode. Before two NFs may interact with each other, they may first need to register with a Network Repository Function (NRF) so they can discover each other via the NRF. Among these NFs, the Access and Mobility Management Function (AMF) is dedicated to managing the WTRU's access to the 5GS and its mobility, the Session Management Function (SMF) is responsible for establishing sessions between a WTRU and the 5GC, and the Authentication Server Function (AUSF) takes charge of WTRU authentication. In addition, the Policy Control Function (PCF) provides policy rules for other control plane network functions and WTRUs. The PCF may assign an identifier for each created policy rule, which other control plane network functions and WTRUs may use to refer to the corresponding policy rule. The User Plane Function (UPF) is the only core network function in the data plane that facilitates monitoring, managing, controlling, and redirecting user plane traffic flows such as between a WTRU and an Application Function (AF). The Network Exposure Function (NEF) may enable access to the 5G control plane functions by entities such as network applications and AFs that are outside the 5GS and not in the same trusted domain. The 5GC may also provide data storage and analytics services through functions such as the Unified Data Management (UDM), the Unified Data Repository (UDR), the Unstructured Data Storage Function (UDSF) and the Network Data Analytics Function (NWDAF). Another important feature of the 5GS is network slicing, which is facilitated by the Network Slice Selection Function (NSSF). 5GS introduces a few NFs, such as the Location Management Function (LMF) to support location services. The LMF is responsible for calculating, determining, or verifying a final location and any velocity estimation and may estimate the achieved accuracy based on location information from the target WTRU and/or a RAN node. After the LMF calculates the location of a target WTRU, other entities can access or query its location from the LMF but need to go through a serving AMF.

Although NFs, such as the NFs described above, are defined as separate logical entities, a particular service scenario may require multiple NFs. For example, WTRU mobility may need not only the AMF but also the AUSF and the SMF. Also, for a type of network function, multiple instances could be instantiated, and the NRF can maintain the information for each instantiated NF instance. With the emergence of edge computing, some NFs in the 5GC, such as the UPF and the NEF could be deployed and may reside in an edge network that is much nearer to and potentially co-located with the RAN.

Two NFs can communicate with each other directly without any entity in the middle or indirectly via an Service Communication Proxy (SCP). In such scenarios, one of the NFs can be considered as a service producer or Function Entity Service Producer (FESP) and the other can be considered as a service consumer or Function Entity Service Consumer (FESC). Where an SCP is involved in the communication between two NFs, the SCP may be responsible for forwarding and routing messages between an NF service consumer and an NF service producer. When two NFS communicate directly with each other, the two NFs can interact with each other using Request/Response model or a Subscribe/Notify model. In a Request/Response model, an NF service consumer may send a request to an NF service producer. The NF service producer may process the request and send a response to the NF service consumer. In a Subscribe/Notify model, an NF service consumer may first send a subscription request to an NF service producer. The NF service producer may process the subscription request and store the subscription information. Whenever any subscribed event occurs, the NF service producer may send a notification to the NF service consumer.

5G security functions may cover four different security domains within 5GS: security for network access between a WTRU and the RAN/5GC, network domain security between a RAN and a 5GC, user domain security between Mobile Equipment (ME) and a Universal Subscriber Identity Module (USIM), and SBA domain security in the 5GC. 5G network access security is realized mainly through network access authentication, message encryption, and message integrity protection. Network access authentication may include primary authentication and key agreement as well as secondary authentication.

Primary authentication and key agreement are designed to enable mutual authentication between a WTRU and a network and agreed keying material (e.g., an anchor key K_{SEAF}) at both the network side and the WTRU side. The basis behind 5G primary authentication and key agreement is that the same long-term key K unique to a WTRU is securely maintained at the USIM at the WTRU and in the network, based on which the anchor key K_{SEAF} and other key materials (e.g., keys for encryption and integrity protection for NAS and AS signaling) can independently and identically be derived at the WTRU and at the network without exchanging them over the air. Mutual authentication may be established when the WTRU and network prove to each other they know the same long-term key K. Since the primary authentication is solely based on the long-term key K, it does not consider user-centric aspects (e.g., user behaviors) and cannot authenticate/differentiate users from the same or different WTRUs.

Secondary authentication is an option to provide security between a WTRU and an external Data Network (DN) as a part of session management. The secondary authentication relies on the SMF to initiate and coordinate the authentication procedure between the WTRU and the DN (e.g., a DN-AAA Server).

A blockchain system could be a permissionless blockchain system (e.g., Bitcoin, Ethereum) where any party or user can use and participate in the blockchain system without pre-granted permissions or a permissioned blockchain system where access to the blockchain system needs to be permissioned, controlled and/or governed. Permissioned Distributed Ledgers (PDLs) as defined by ETSI Industry Specification Group (ISG) on PDL is an example of a permissioned blockchain system. ETSI ISG on PDL publishes Group Reports (GRs) and Group Specifications (GSs) on various topics, such as PDL reference architecture, use cases, specific PDL functionalities, and vertical domains. ETSI GR PDL-021 describes use cases where PDL can be leveraged and integrated with a 3GPP system such as 5GS. ETSI GS PDL-024 develops standards for provisioning PDL services within a 3GPP system. Three functions are being defined in ETSI GS PLD-024: Distributed Ledger Anchor Function (DLAF), Distributed Ledger Repository Function (DLRF), and Distributed Ledger Enabler (DLE). DLAF and DLRF are two new control plane functions for the 3GPP system, while DLE likely will be a data plane function. ETSI GS PDL-027 aims to develop and specify the technical requirements and solutions based on PDL to build a native Self-Sovereign Identity (SSI) system under the constraints of telecommunications networks so that a user or a network node holding such an identity can seamlessly access network services among different operators and service providers.

Trust refers to a measurable belief that represents an accumulated value (e.g., about the quality/behavior/performance/characteristic of a network node, a WTRU, a service or any logical/physical entity) from history and the expected value for the future. Trust can be objective trust or subjective trust. Objective trust leverages the security mechanism, such as authentication, to validate an entity's identity. However, trust extends beyond security. For example, an entity passing the authentication only means the entity has successfully proved its identity, it still may not be fully trusted since the trust about the entity's behavior/characteristics could still be dynamically changing and the criteria for evaluating trust may also be subjective (e.g. based on user/personal experience/preference). Trust is an important input for decision making and is usually measured or calculated based on the history experience/records in the past, and it represents the expected value of quality, behavior, characteristics, and/or performance in the future.

A trust index may be obtained via a trust evaluation process and can be used to describe the trust of an entity. The trust index is an overall metric, which is often calculated based on the aggregation of one or more trust indicators (depending on the user's subjective trust evaluation criteria) using certain trust evaluation algorithms. The trust indicators may cover various aspects, such as security, privacy, resilience, performance, robustness, scalability, availability, accuracy, reliability, and/or consistency. During a trust evaluation process, various data about an entity can be collected and those data could be used as inputs to calculate various trust indicators, which in turn may be aggregated into an overall metric, which may be referred to as the current trust index of the entity. Trust has various characteristics. For example, trust is dynamic, meaning that a given trust index may be applicable for a limited time period and may change as time goes on. Trust is also context-dependent, which means that the trust can have a significant change if the context gets changed. Trust is not transitive in nature, but trust may be transitive in some particular contexts. Similarly, trust is an asymmetric relationship, meaning that a fact of entity A trusting entity B cannot deduce that entity B also trusts entity A. In addition, trust could also be subjective, which means that, for the same entity, different users may have different criteria/opinions/preferences regarding how to evaluate the trust of this entity and what kinds of trust-related aspects/indicators shall be considered.

Conventional cellular wireless systems, such as 5GS, provide various security functions as defined in, for example, 3GPP TS 33.501, such as primary authentication during registration, secondary authentication during Protocol Data Unit (PDU) session establishment, NF service authorization, network slicing-specific authentication and authorization, network slicing admission control, data plane encryption and integrity protection. NF service authorization in 5GS can be static authorization or token-based authorization. In static authorization, some local authorization policies are maintained at the NRF and the NF service producer. Those local authorization policies may be used to authorize a NF service consumer, when the NF service consumer discovers NF service producers from the NRF or when it requests to access services from a discovered NF service producer. In token-based authorization, the NRF can grant an access token to a NF service consumer. Then, the NF service consumer may present the access token to the NF service producer, which may authorize the NF service consumer based on the access token.

It is anticipated that a user may need to access services provided by a network and/or a WTRU with highly dynamic behavior. Examples of services could be NWDAF, AI as a Service (AIaaS), Computation as a Service (CaaS), Sensing as a Service, etc. Dynamic behaviors could include the user accessing services from a new location, a user accessing services via different devices at different times, a user switching to access services provided by another device for a reduced latency or other improvement in performance or experience, etc. Such dynamic behaviors may lead to changing trustworthiness among interacting and involved entities (e.g., users, devices, NFs, and/or networks). For example, a previously established relationship between a user and an NF may become not trustable anymore as time passes. The user could be a human user, an application on a device, an application within a network, a device behind another device, or another logical entity as a service consumer.

FIG. 2 is a diagram 200 showing examples of dynamic service access from a user. In the example illustrated in FIG. 2, a first example scenario 210 shows a user 320 using a first WTRU 222 to access services from a network 250. The network 250 may be, for example, an edge, core or cloud network, which may include a number of different NF service producers, including NF1 252, which may be an AIaaS function, NF2 254, which may be a CaaS function, an NF3 256, an NF4 258, and an NF5 260. The user 220, still using the first WTRU 322, moves to a new location, such as a train station and continues to access services from the network (such as the AIaaS provided by NF1 252). Moving to a public area with more potential security attacks may lead to a change in the trust of the user 220 and/or the first WTRU 222.

In a second example scenario 225 illustrated in FIG. 2, the user 220 boards the train with the first WTRU 222, and the train has a mounted WTRU 224 that provides better wireless connectivity and overall performance to the user while the train is moving. The first user then associates with and uses the second WTRU 224 to access network services (e.g., CaaS provided by NF2 254). For example, the second WTRU 224 may provide WiFi-based hotspot service within the train. Each seat may have a build-in WiFi terminal. As a result, the first user 220 uses the built-in WiFi terminal to connect to the second WTRU 224 and eventually to access network services. Alternatively, the user 220 may still use the first WTRU 220 to connect to the second WTRU 224 (via WiFi or sidelink) and then access network services.

In a third example scenario 230 illustrated in FIG. 2, while using AIaaS from NF1 252, the user 220 using the first WTRU 222, arrives at a shopping mall and gets off the train. It turns out that a third WTRU 226, such as a WTRU at a store, in the proximity of the first WTRU 220 also provides needed AIaaS and may provide a store-customized AI model for shopping suggestions for free. The user 220 then begins accessing AIaaS services using the third WTRU 226 and stops using AIaaS using the first WTRU 220.

In these dynamic service access scenarios, the user 220's context (e.g., the location of the user 220, the WTRU that the user 220 is associated with, and the location of services being accessed) changes from time to time. As such, the trust index of the user 220 may be changing too. Accordingly, it may be important to dynamically assess and/or reassess the user 220's authorization to access network services or services provided by a WTRU. 5GS, however, currently has the following limitations in supporting reassessment of a user's authorization to access services. First, 5GS does not provide for a dynamic user context and does not support dynamic user authentication. Primary authentication in 5GS is based on statically configured information (e.g., the root key in USIM), which cannot reflect or capture a dynamically changing user context and user trust index. Static authorization in 5GS is only based on local authorization policies, which cannot reflect or capture the dynamically changing user context and/or user trust index. In token-based authorization in 5GS, an access token cannot reflect or capture a dynamically changing user context and/or user trust index. Second, 5GS does not support dynamic user authentication based on user trust index. Although some solutions regarding user identifier and user authentication have been proposed, they do not reflect or support a user trust index. Without solutions for this issue, the wireless system may just authenticate a user once, and that single authentication enables the user to access network services for a very long time, even when the user context changes, resulting in a degraded user trust index, or when a service provider's trust changes. Thus, wireless systems may be less secure and more vulnerable to potential attacks.

Additionally, when an NF service consumer and an NF service producer interact with each other using a Subscribe/Notify model, the NF service producer may send multiple notifications across a period of time to the NF service consumer. During this period of time, the trust index of either the NF service consumer or the NF service producer may shift. As a result, the previously established trust relationship between the NF service consumer and the NF service producer should be re-assessed. This may be referred to as Continuous Authentication and Authorization (CAA) based on trust index. However, 5GS does not currently support such CAA. Accordingly, it may be desirable to enable and enforce CAA for an NF service consumer, in a wireless system, using a trust index. For example, when the trust index of the NF service consumer decreases, it may become not trustable anymore. Thus, the NF service producer should throttle or stop sending new notifications to it. It may also be desirable to enable and enforce CAA for the NF service producer using its trust index. For example, when the trust index of the NF service producer decreases, future notifications issued by it may not be trustable.

Embodiments described herein provide for trust-based authentication considering a user trust and/or a device trust that may be flexible and applicable for different scenarios avoid introducing high communication or computation overhead to devices, compatible with 3GPP architecture, and integrated with 3GPP SA procedures. This may result in a more user-aware wireless system by incorporating user trust index, device trust index, and service producer trust into user authentication and more secure service interaction via trust-based authentication considering dynamically changing user trust index.

In some embodiments, a Subscribe/Notify mode of service interaction may be used for communications between an FESC and an FESP. To enable trustworthy service interactions between an FESC and an FESP using a Subscribe/Notify mode of service interaction, CAA based on trust may be added as a functionality of the FESP and the FESC to enable the FESC and the FESP to authenticate each other by considering the dynamic trust index of the FESC and the FESP. CAA may be performed and enforced during the period of time after the FESC subscribes to the FESP. In some embodiments, the FESP and the FESC may perform Dynamic Trust-based Authentication (DTA) repeatedly (i.e., CAA) during the lifetime of a service subscription the FESC may have with the FESP.

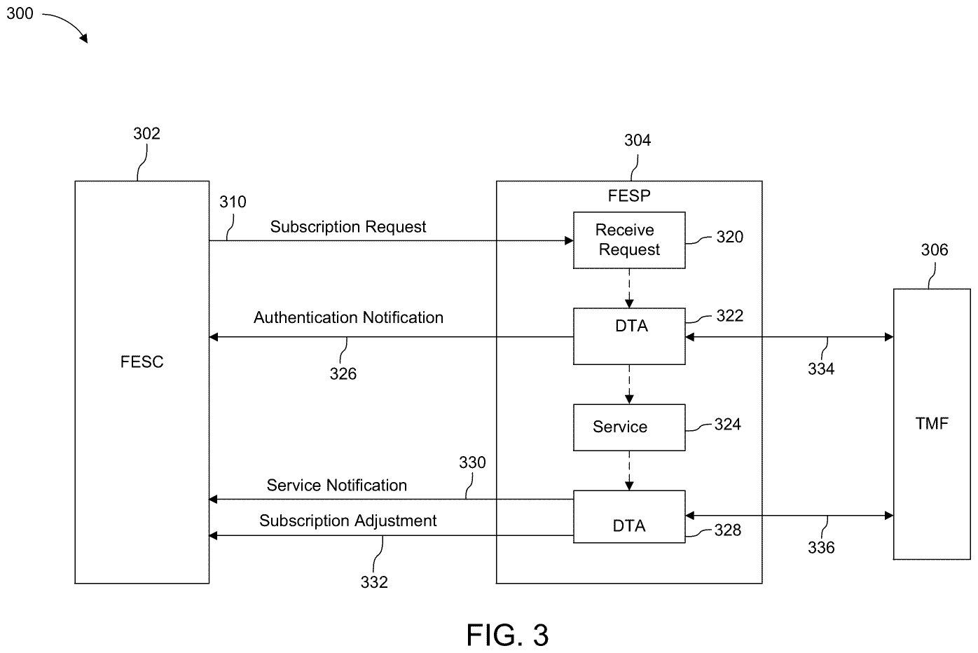

FIG. 3 is a system diagram 300 of an example dynamic trust-based authentication architecture for subscribe/notify-based service interaction. In the example illustrated in FIG. 3, an FESC 302 seeks access to a target service provided or hosted by an FESP 304. Using a Subscribe/Notify-based approach (i.e., Subscribe/Notify mode of service interaction), for example, the FESP 304 may provide the target service for a period of time and may repeatedly generate and deliver service results to the FESC 302. The FESC 302 may be a device or a user of a device that requests to access services provided by an FESP, while the FESP may be an NF or a service within a network (e.g., 5G or 6G network) or on a device that provides services to service consumers. The TMF may provide services for evaluating, calculating and exposing a User Trust Index (UTI), a Device Trust Index (DTI), and/or a trust index of the FESP. The TMF may be within the network (e.g., 5G or 6G network) or a third-party entity.

In the example illustrated in FIG. 3, the FESC 302 sends, to the FESP 304, a subscription request 310 for the target service. The FESP 304 may receive the subscription request (320) and perform some processing, such as credential-based authentication. The FESP 304 may also retrieve or receive a trust index (334) of the FESC 302 from a trust management function (TMF) 306. The FESP 304 may use the trust index of the FESC 302 to perform a first Dynamic Trust-based Authentication (DTA) (322) over the subscription request received from the FESC 302. The FESP 304 may send an authentication notification 326 to the FESC 302, and the authentication notification 326 may contain a trust-based authentication result. The authentication notification may be a subscription response, which can be regarded as a response to the subscription request 310. If the FESC 302 has an acceptable trust index and is permitted to request the target service according to the dynamic trust-based authentication, the FESP 304 may execute the target service (324) for the FESC 302.

When the execution of the target service is completed, the FESP 304 may collect service results. Before sending service results in a service notification to the FESC 302, however, the FESP 304 may retrieve or receive the trust index of the FESC 302 again (336) and perform a second DTA (328) to check if the FESC 302's trust index has been changed or if it is still authorized to receive service notifications. If the second dynamic trust-based authentication passes, the FESP 302 may send a service notification 330 containing service results to the FESC 302. If the second Dynamic trust-based authentication fails, the FESP 304 may send a subscription adjustment 10 to the FESP 304. An example of such a subscription adjustment could be to cancel the original subscription request. However, other types of adjustments may be made, as described in more detail below.

Using the architecture shown in FIG. 3, the FESP may establish a service subscription with an FESC, update and/or cancel an established service subscription, generate service notifications for the FESC, and/or adjust the established service subscription.

To establish a service subscription with an FESC, a User/Device may send a service subscription request to an FESP indicating the User/Device's interest in certain service events of target services and may expect to receive service notifications from the FESP when service events occur. In other words, one subscription request from a User/Device may lead to repeated or periodical service notifications issued by the FESP for as long as the subscription is active (e.g., FESC and FESP trust criteria is met, subscription has not expired, or subscription has not been canceled by the User/Device). The FESP may first, however, jointly perform WTRU-level-authentication, user level authentication, and/or trust-based authentication over the service subscription request to determine if the User/Device is allowed to subscribe to the target services. For trust-based authentication, an FESP may retrieve an FESC's UTI and DTI from the TMF and determine if a User/Device can be trusted based on the UTI and DTI. A User/Device can similarly obtain the trust index of an FESP from the TMF and may determine if the FESP can be trusted based thereon.

After the subscription request is authenticated, the FESP may begin to trigger target services and monitor expected service events for the User/Device. When an expected service event occurs, the FESP may generate and send a service notification to the User/Device.

In the meantime, the FESP may periodically receive trust index notifications about UTI and DTI from the TMF, and the FESP may adjust the way it is handling the subscription request based thereon. For example, the FESP may reduce the rate of sending service notifications to a User/Device if the UTI and/or DTI of the User/device decreases. For another example, the FESP may cancel the subscription request if the UTI and/or DTI of the User/device becomes too low (e.g., below a threshold). For yet another example, the FESP may increase the rate of sending service notifications to a User/Device if the UTI and/or DTI of the User/device increases.

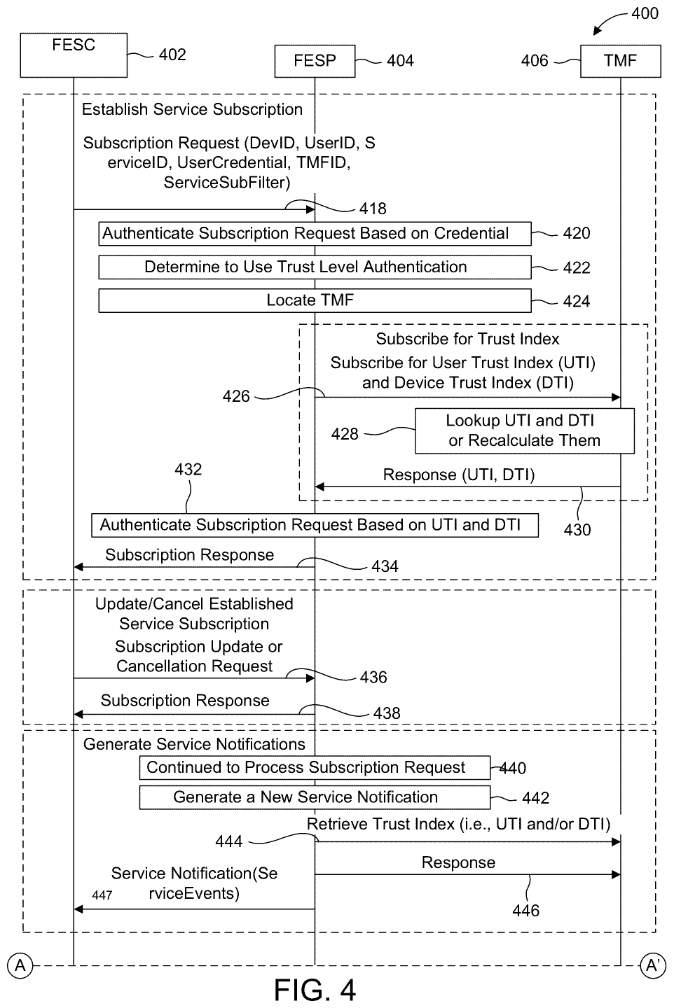

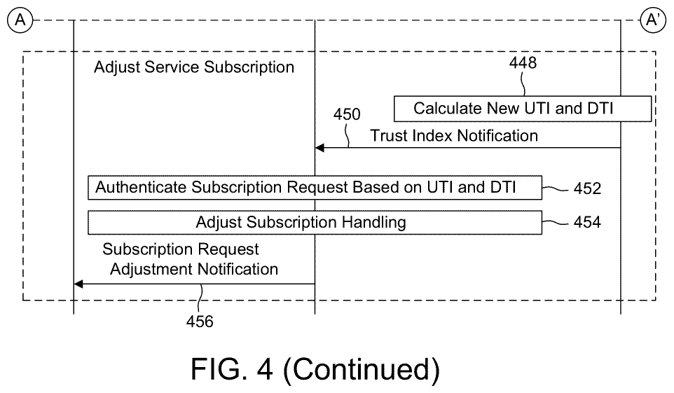

FIG. 4 is a signal diagram 400 showing an example of trust-based authentication for subscribe/notify-based service interaction using continuous authentication and authorization on or for an FESC 402. In the example illustrated in FIG. 4, the FESC 402 has discovered the FESP 404, such as from the NRF or other repository function.

The FESC 402 may send a service subscription request 418 to the FESP 404. The service subscription request 418 may contain one or more parameters, which may be or include one or more of ServiceSubFilter, SubValidTimer, TMFID, UserID, DevID, ServiceID, UserCredential, UTI, DTI ResponseTimer and/or the identifier of the FESP. The parameter ServiceSubFilter may be used to describe service events and/or conditions for generating a service notification. For example, if the target service is AIaaS for training a series of models, the parameter ServiceSubFilter may specify that a service notification should be generated and sent to the FESC 402 after each model is trained and tested with a model accuracy of 98% or above. The parameter SubValidTimer may provide the validity time of the subscription being requested after which time the FESP 404 will automatically cancel/remove this subscription. The parameter TMFID may provide the identifier of a TMF that can calculate and expose the trust index of the FESC 402. The parameter DevID may provide the identifier of the Device, and the parameter UserID may provide an identifier of the user of the device. The parameter ServiceID may provide the identifier or the name of target services that the FESC 402 subscribes to. The parameter UserCredential may provide the credential or access token of a User that can be used to authorize the User. Since service subscriptions cause much higher overhead at the FESP than a one-time service request, the UserCredential parameter may be designed to have a granted permission to issue a service subscription request to the FESP. The Response Timer parameter may correspond to a timer indicating a time period within which the FESP needs to send a subscription response to the FESC. The parameter UTI may provide the trust index of the User which may have been signed by TMF. The parameter DTI may provide the trust index of the Device which may have been signed by TMF.

The FESP 404 may receive the service subscription request 418 and may authenticate and authorize the subscription request (420), for example using the UserCredential parameter. For example, the FESP 404 may verify whether UserCredential grants the right for the FESC 402 to subscribe to the target services identified by the ServiceID parameter.

If authentication using UserCredential fails, the FESP 404 may forward the service subscription request 418 and/or a failed authentication indication to the TMF 406, which may recalculate and update the trust index of the User/Device (e.g., by decreasing it) according to the service subscription request and the failed authentication indication. The TMF 406 may send a response to the FESP 404 indicating receipt of the failed authentication indication and/or the recalculated trust index of User/Device. The TMF 406 may also send the recalculated trust index of the User/Device to the User/Device itself and/or other entities which have subscribed to receive the trust index of the User/Device.

If authentication using UserCredential is successful, the FESP 404 may forward the service subscription request 418, and/or send a successful authentication indication, to the TMF 406, which may recalculate and update the trust index of the User/Device (e.g., by increasing it) based on the service subscription request 418 and/or the successful authentication indication. The TMF 406 may send a response to the FESP 404 indicating receipt of the successful authentication indication and/or the recalculated trust index of the User/Device. The TMF 406 may also send the recalculated trust index of the User/Device to the User/Device itself and/or other entities which have subscribed to receive the trust index of the User/Device.

The FESP 404 may determine to use DTA to further authenticate and authorize the subscription request using trust level authentication (422). For example, the FESP 404 may have been provisioned some local policies specifying that any subscription request from a User for this ServiceID needs to be authenticated using DTA.

If the parameter TMFID was not included in the subscription request 418, the FESP 402 may determine or select a TMF (424), from which the FESP 402 can retrieve the trust indices of FESCs. The FESP 402 may have been configured with some TMFs that it may select from, for example.

The FESP 404 may send a trust index subscription request 426 to the TMF 406. The trust index subscription request may contain one or more parameters, which may be or include one or more of FESPID, the identifier of a User and/or the identifier of a Device, FESPCredential, ServiceID, TrustIndexSubFilter and/or ImmediateNotifFlag. The parameter FESPID may provide the identifier of the FESP. The parameter FESPCredential may provide the credential of the FESP that allows the FESP to subscribe to the trust index of the User/Device. The ServiceID parameter may indicate the identifier of target services that the User/Device subscribed to. The TMF 406 may calculate the UTI and the DTI differently for different ServiceID. The TrustIndexSubFilter parameter may indicate one or multiple trust index conditions for the TMF to recalculate and/or send the latest UTI/DTI of the User/Device to the FESP. If multiple trust index conditions are indicated, this parameter may also indicate how the multiple trust index conditions will be used to determine to generate a trust index notification (e.g., if and only if all conditions are satisfied, when any one or multiple of these conditions is satisfied). Examples of trust index conditions may include: recalculating and sending UTI/DTI every 10 minutes, sending UTI when it is below a threshold, sending DTI when it is below a threshold, sending UTI when it is within a range, sending DTI when it is within a range, sending UTI when it is outside of a range, sending DTI when it is outside of a range, sending UTI when it is above a threshold, sending DTI when it is above a threshold, not sending UTI when it is within a range, not sending DTI when it is within a range, sending UTI when it is increased by certain amount, sending DTI when it is increased by a certain amount, sending UTI when it is decreased by a certain amount, and sending DTI when it is decreased by a certain amount. The ImmediateNotiFlag parameter may be set to TRUE to indicate that the FESP needs an immediate notification about the latest UTI and DTI.

The TMF 406 may authenticate the FESP 404 if the FESP 404 is allowed to subscribe to the UTI/DTI of the User/Device based on the parameter FESPCredential. The TMF 406 may also authenticate whether the conditions contained in the TrustIndexSubFilter parameter are allowed. If ImmediateNotifFlag=TRUE or 1, the TMF may look up or recalculate the latest UTI and DTI (428).

The TMF 406 may send a response 430 to the FESP 404. The response 430 may contain the latest UTI and DTI. In addition, the response 406 may indicate whether the subscription request 426 was approved, provide a list of allowed trust index conditions, and/or provide a list of rejected trust index conditions.

The FESP 404 may perform DTA to authenticate the service subscription request 418 received from according to the received DTI and UTI (432), which may be received from 418 or 530, and generate authentication results. For example, the FESP 404 may approve the service subscription request only if DTI and/or UTI are above a threshold. Otherwise, the FESP 404 may reject the service subscription request 418. For another example, the FESP 404 may assign a lifetime (e.g., 2 days) for the approved service subscription request to overwrite SubValidTimer as received from 418. The lifetime may depend on UTI and/or DTI. For example, the higher the User/Device's UTI/DTI is, the longer the lifetime of the approved service subscription request may be.

The FESP 404 may send a subscription response 434 to the FESC 402, which may contain the authorization results (e.g., the determined lifetime for the approved service subscription request) and the UTI/DTI received from the TMF 406. The subscription response 434 may contain a list of allowed service event conditions or a list of rejected event conditions. All original service event conditions may have been contained in the ServiceSubFilter parameter in the subscription request 418. The subscription response 434 may also contain the identifier of the approved subscription (e.g., ApprovedSubID). The subscription response 434 may include a CAA indication indicating that the FESP will perform repeated DTA on or for the User/Device whenever a new service notification is generated for the User/Device.

If the FESC 402 does not receive the subscription response 434 before the timer or time period corresponding to the ResponseTimer parameter expires, the FESC 402 may determine that the FESP 404 has not received or has not processed the subscription request 418 and may send a failure message to the TMF 406, for example indicating that the FESC did not receive the subscription response from the FESP before the Response Timer expired at location L1, where L1 is the current location of the User/Device corresponding to the FESC 402. The failure message may contain the subscription request 418. The TMF 406 may receive the failure message and recalculate the trust index of the FESP (e.g., by decreasing it) according to the failure message. The TMF 406 may send a response to the User/Device indicating receipt of the failure message and/or the recalculated trust index of the FESP. The TMF 406 may also send the recalculated trust index of the FESP to the FESP itself and/or other entities which have subscribed to receive the trust index of the FESP.

After successfully receiving each subscription response, the FESC 404 may send a success message to the TMF 406, indicating, for example, that the User/Device received the subscription response from the FESP at time T1 and at location L1, where T1 is the time the subscription response was received and L1 is the current location of the User/Device. The success message may contain the subscription request 418. The TMF 406 may then recalculate the trust index of the FESP (e.g., by increasing it) according to the success message. The TMF 406 may send a response to the FESC 402 indicating receipt of the success message and/or the recalculated trust index of the FESP. The TMF 406 may also send the recalculated trust index of the FESP to the FESP itself.

The FESC 402 may send a subscription update or cancellation request 436 to the FESP 404. For example, the FESC 402 may use the subscription update or cancellation request 436 to cancel the service subscription that was previously established, for example, if the subscription response 434 contains too many rejected service event conditions. The subscription update or cancellation request 436 may also contain the parameter ServiceNotifAddr, which may indicate the address for later receiving a service notification. The subscription update request 436 may include new values of one or more parameters as included in the original service subscription request 418. The FESP may send a subscription response 438 to the FESC 402 indicating that the corresponding subscription has been updated or canceled, as requested. If the subscription has been canceled, this may terminate the process that was started when the FESC 402 sent the subscription request 418. This can happen at any time after the FESC successfully subscribes to the FESP.

If the established service subscription is not previously canceled, the FESP 404 may continue to process the service subscription request 418 (440) according to the new subscription parameters contained in 436 and may begin monitoring expected service events that may have been indicated by the ServiceSubFilter parameter. When an expected service event occurs, the FESP 404 may generate a new service notification (442).

By the time the expected service event occurs, the UTI/DTI of the FESC 402 may have been changed. The FESP 404 may need to check the latest UTI and DTI to make sure that the FESC 402 is still trustable enough to receive the service notification. Thus, the FESP 404 may send a request 444 to the TMF 406 to retrieve the UTI and DTI. This request may contain the identifier of the FESP (e.g., FESPID), the identifier of User (e.g., UserID), and the identifier of the Device (e.g., DevID), ServiceID.

The TMF 406 may receive the request 444 and may recalculate the UTI and DTI. The TMF 406 may send the UTI and DTI in a response 446 to FESP 404.

If the FESP 404 subscribed to receive automatic notifications about UTI/DTI from the TMF 406, the request 444 may not be needed, in which case the response 446 may actually be a notification containing the latest UTI and DTI. In this case, the new service notification may be generated after the notification containing the latest UTI and DTI is sent. In another example, the FESP 404 may have subscribed to receive automatic notification about UTI/DTI from the TMF 406 only if UTI/DTI is below a threshold; if there is no any notification from the TMF 406, it implies that UTI/DTI is still good enough and thus the FESP 404 may send the service notification to the FESC 402. In some embodiments, the latest UTI and DTI may be sent multiple times, and the TMF 406 may send multiple notifications of the latest UTI and DTI to the FESP 404. The FESP 404 may store the latest UTI and DTI received from TMF 406.

As an alternative approach to 444 and 446, when a new service notification is generated, the FESP 404 may send a message to the FESC 402 indicating that a new service notification is generated but the FESC 402 needs to present its latest UTI and DTI to the FESP in order to retrieve the new service notification or in order that the FESP 404 may push the new service notification to the FESC 402. The message may also contain the identifier of the FESP 404, the identifier of the service subscription request 418, and/or the identifier of the new service notification. The FESC 402 receives the message. If the FESC 402 determines to receive or retrieve the new service notification from the FESP 404, the FESC 402 may send a trust index retrieval request to a TMF to get the latest UTI/DTI. The trust index retrieval request may contain the identifier of the User, the identifier of the Device, the identifier of the FESP, ServiceID, etc. The TMF may receive the trust index retrieval request and may recalculate UTI/DTI. The TMF may generate a trust index retrieval response containing the recalculated UTI/DTI and send the trust index retrieval response to the FESC 402. The FESC 402 may receive the recalculated UTI/DTI from the TMF and may send the recalculated UTI/DTI to the FESP 404 in order to receive or retrieve the new service notification. The FESP 404 may receive the recalculated UTI/DTI from the FESC and determine whether to send the new service notification to the FESC 402 or not.

The FESP 404 may receive the latest UTI and DTI from the TMF 406 or from the FESC 402 and may use it to determine whether to send a service notification 447 to the FESC 402 or not. For example, if the UTI and/or DTI is/are high enough, the FESP 404 may send the service notification generated in 444 to the FESC 402. For another example, if the UTI and/or DTI is/are below a threshold, the FESP 404 may not send the service notification to the FESC 402. The service notification 447 may also contain the UTI and/or DTI received in the response or indication 446.

The FESP 404 may request that the FESC 402 send a confirmation for each service notification 447. If the FESP 404 does not receive the confirmation after some time, it may regard the FESC 402 as unreachable and send a failure message to the TMF 406, indicating, for example, that the User/Device is unreachable to receive the service notification sent by the FESP at time T1, where T1 is the time that the service notification was sent. The failure message may include the service notification. The TMF 406 may then recalculate the trust index of the User/Device according to the failure message (e.g., by reducing the trust index of User/Device) and may send a response to the FESP 404 indicating receipt of the failure notification and/or the recalculated trust index of User/Device. The TMF 406 may also send the recalculated trust index of the User/Device to the User/Device itself and/or other entities which have subscribed to receive the trust index of the User/Device.

After successfully receiving each service notification, the FESC 402 may send a success message to the TMF 406, indicating, for example, that the User/Device received the service notification from the FESP at time T1 at location L1, where T1 may be the time the service notification was received and L1 may be the current location of the User/Device corresponding to the FESC 402. The success message may include the service notification. The TMF 406 may then recalculate the trust index of the FESP 404 (e.g., by increasing its trust index). The TMF 406 may send a response to the FESC 402 indicating receipt of the success message and/or the recalculated trust index of the FESP. The TMF 406 may also send the recalculated trust index of the FESP to the FESP itself and/or other entities which have subscribed to receive the trust index of the FESP.

The TMF 406 may continue to monitor and recalculate UTI and DTI (448), for example according to the parameter TrustIndexSubFilter. After some time, the newly calculated UTI and DTI may satisfy the trust index conditions contained in the parameter TrustIndexSubFilter. Thus, the TMF 406 may generate a trust index notification containing the latest UTI and DTI, along with the identifier of the TMF. The TMF 406 may then send a trust index notification 450 to the FESP 404. The FESP 404 may re-authenticate the service subscription request 418 based on the latest UTI and DTI (452). The trust index notification may also include the identifier of the User, the identifier of the Device, the identifier of the FESP, and/or the identifier of the trust index subscription request 426.

The FESP 404 may adjust its handling of the service subscription request (454) (also referred to as making subscription adjustments). For example, the FESP 404 may reduce the rate at which it sends service notifications to the FESC 402 if the UTI and/or DTI decreases. Otherwise, the FESP 404 may increase the rate at which it sends service notifications to the FESC 402 if the UTI and/or DTI increases. For another example, the FESP 404 may remove some service event conditions or narrow the scope of expected service events if the UTI and/or DTI is/are below a threshold. The FESP 404 may resume all requested service event conditions or recover the scope of expected service events if the UTI and/or DTI is/are above a threshold. For another example, the FESP 404 may pause the service subscription request 418 for a certain duration of time or until the UTI and/or DTI rises above a threshold. In yet another example, the FESP 402 may cancel the original service subscription request if the UTI and/or DTI is/are below a threshold.

The subscription adjustments (454) may be sent to the FESC 402 in the form of a service subscription request adjustment notification 456. After the FESC 402 receives the service subscription request adjustment notification 456, the FESC 402 may be more prepared to receive more service notifications, a less number of service notifications, or no notifications at all.

A subscription to a target service, such as generative AI (a service providing computation-intensive large model finetuning and inference) in a subscribe/notify model may remain active for a long period of time, and the trust index of an FESP could change over that time. As such, the FESP's trust index may fall below trust criteria of the FESC, and, accordingly, service notifications sent from the FESP may become not trustworthy. In some embodiments, therefore, the FESC may perform continuous authentication and authorization on or for the FESP whenever a new service notification is received from the FESP.

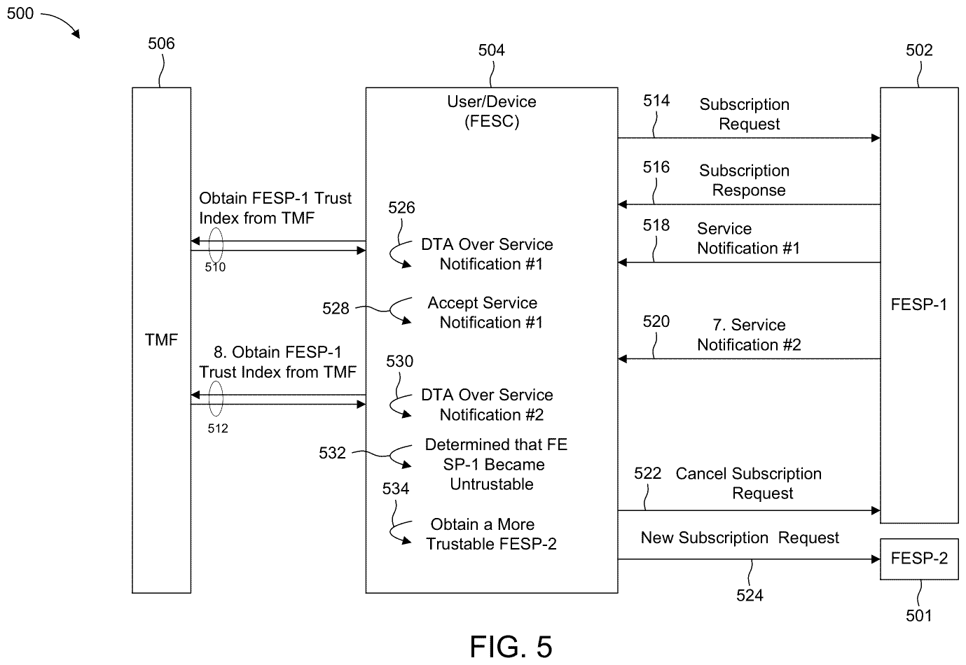

FIG. 5 is a signal diagram 500 showing an example trust-based authentication for subscribe/notify-based service interaction using continuous authentication and authorization on or for an FESP. In the example illustrated in FIG. 5, an FESC 504 has discovered a first FESP 502, such as from the NRF or other repository function.

The FESC 504 may send a service subscription request 514 to the first FESP 502. The service subscription request 514 may indicate that the FESC 504 will perform CAA on the first FESP 502 by enforcing DTA for each received service notification. The first FESP 502 may receive the service subscription request 514. The service subscription request 514 may contain one or more parameters, such as any of the parameters described above that may be sent in the service subscription request 418 of FIG. 4. The first FESP 502 may behave as the FESP 404 described above, authenticating the subscription request based on a credential (420), determining to use trust level authentication (422), locating a TMF (424), subscribing for UTI and DTI (426), receiving the UTI and DTI from the TMF (428 and 430), and authenticating the subscription request based on the received UTI and DTI (432). The first FESP 502 may send a subscription response 516 to the FESC 504. The subscription response 516 may also contain a TMF identifier (TMFID), the identifier of a TMF from which the FESC 504 can retrieve the trust index of the first FESP 502. The subscription response 516 may contain one or more parameters, such as any of the parameters described above that may be sent in the service subscription response 434 of FIG. 4. The trust index of the first FESP 502 may be recalculated by the TMF, for example, using any of the methods described in FIG. 4.

The first FESP 502 may send a first service notification 518 to the FESC 504. The first service notification 518 may contain service results and subscribed service events. This notification may also contain the latest trust index of the first FESP 502 (e.g., FESP1TI) signed by the TMF that calculated it. The trust index of the first FESP 502 and the User/Device may be recalculated, for example, using any of the methods described in FIG. 4.

The FESC 504 may receive the first service notification 518 and may check whether the trust index FESP1TI for the first FESP 502 is indicated by the first service notification 518. If the trust index FESP1TI is not indicated by the first service notification 518, or if the trust index FESP1TI is indicated by the first service notification 518 but is outdated or invalid, the FESC 504 may send a request containing the identifier of the first FESP 502 to a TMF 506 and may receive the latest trust index of the first FESP 502 from the TMF 506 (510). If the trust index FESP1TI is indicated by the first service notification 518, the FESC 504 may verify that its signature (e.g., the signature of the TMF that calculated the FESP1T1) is valid and then perform DTA using the trust index FESP1TI (526). For example, if FESP1TI is greater than a threshold, the FESC 504 will regard the first FESP 502 as trustable, accept the first service notification 518 (528), and utilize the notification information.

After some time passes, the first FESP 502 may generate a second service notification 520 and may send it to the FESC 504. The trust index of the FESC 504 and/or the trust index of the first FESP 502 may be recalculated, for example, using any of the methods described in FIG. 4.

The FESC 504 may obtain the latest trust index of the first FESP 502 from the TMF 506 (512). The FESC 504 may perform DTA again (530) using the latest trust index of the first FESP 502 and, based on the results, may determine whether to accept the second service notification 520 or not. If the first FESP 502 does not pass the DTA, for example because the latest trust index of the first FESP 502 is below a threshold, the FESC 504 may determine that the first FESP 502 is not trustable by the FESC 504 (532) and may discard the service notification 520 that was received from the first FESP 502. The FESC may also send a request 522 to the first FESP 502 to cancel the service subscription that was established as a result of the subscription request 514. The FESC 504 may discover another FESP from a repository function or from its local list of preconfigured FESPs, the second FESP 501, which may meet the trust criteria of the FESC 504 and may also support the same target services that the FESC 504 subscribed to using the subscription request 514. If the second FESP 504 meets the trust criteria of the FESC 504 and supports the target services the FESC 504 is interested in, the FESC 504 may send a new service subscription request 524 to the second FESP 501. The second FESP 501 may process the request and send a new service subscription response to the FESC 504. The contents of the new subscription request 524 may be the same as, or similar to, the subscription request 514, and the contents of the new subscription response (not shown in FIG. 5) may be the same as, or similar to, the subscription response 516.

While the embodiments illustrated in FIGS. 4 and 5, and described in the corresponding text, use direct communication between an FESC and at least one FESP, in some embodiments, an FESC may indirectly subscribe to target services provided by an FESP via an SCP. In such embodiments, the SCP may perform CAA on the FESP during the lifetime of a service subscription that the FESC creates.

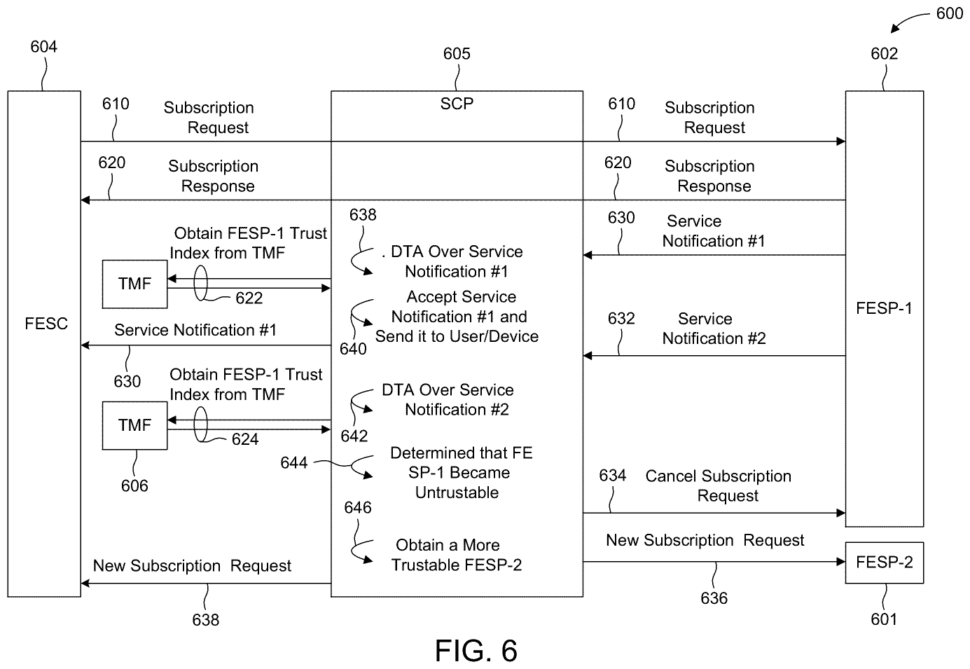

FIG. 6 is a signal diagram 600 showing an example trust-based authentication for subscribe/notify-based service interaction using an SCP 605 to perform continuous authentication and authorization on or for an FESP 602. In the example illustrated in FIG. 6, the FESC 604 has discovered at least a first FESP 602, such as from the NRF or other repository function.

The FESC 604 may send a service subscription request 610 to the first FESP 604 via the SCP 605. The service subscription request 626 may contain one or more parameters, such as any of the parameters described above that may be sent in the service subscription request 402 of FIG. 4 and the service subscription request 514 of FIG. 5.

The first FESP 602 may behave as the FESP 404 and the first FESP 502 described above, authenticating the subscription request based on a credential (420), determining to use trust level authentication (422), locating a TMF (424), subscribing for UTI and DTI (426), receiving the UTI and DTI from the TMF (428 and 430), and authenticating the subscription request based on the received UTI and DTI (432). The first FESP 602 may send a subscription response 620 to the SCP 605, which may forward it to the FESC 604. The subscription response 620 may also contain a TMF identifier (TMFID), the identifier of a TMF from which the FESC 604 can retrieve the trust index of the first FESP 602. The subscription response 620 may contain one or more parameters, such as any of the parameters described above that may be sent in the service subscription response 434 of FIG. 4. The trust index of the first FESP 602 and/or the trust index of the FESC 604 may be recalculated, for example, using any of the methods described in FIG. 4.

The first FESP 602 may send a first service notification 630 to the SCP 605. The first service notification 630 may contain service results and subscribed service events. This notification may also contain its latest trust index (e.g., FESP1TI) signed by the TMF that calculated it. The trust index of the FESC 604 may be recalculated, for example, using any of the methods described in FIG. 4.

The SCP 605 may obtain the latest trust index of the first FESP 602 from the TMF 606 (622).

The SCP 605 may receive the first service notification 630 and may check whether the trust index FESP1TI for the first FESP 602 is indicated by the first service notification 630. If the trust index FESP1TI is not indicated by the first service notification 630, or if the trust index FESP1TI is indicated by the first service notification 630 but is outdated or invalid, the SCP 605 may send a request containing the identifier of the first FESP 602 to the TMF 606 and may receive the latest trust index of the first FESP 602 from the TMF 606 (622). If the trust index FESP1TI is indicated by the first service notification 630, the SCP 605 may verify that its signature is valid and then perform DTA using the trust index FESP1TI (638). For example, if FESP1TI is greater than a threshold, the SCP 605 will regard the first FESP 602 as trustable, accept the first service notification 630 (640), and send the first service notification 630 to the FESC 604.

After some time passes, the first FESP 602 may generate a second service notification 632 and may send it to the SCP 605. The trust index of the FESC 605 and/or the trust index of the first FESP 602 may be recalculated, for example, using any of the methods described in FIG. 4.

The SCP 605 may obtain the latest trust index of the first FESP 602 from the TMF 606 (622). The SCP 605 may perform DTA again (642) using the latest trust index of the first FESP 602 and, based on the results, may determine whether to accept the second service notification 630 or not. If the first FESP 602 does not pass the DTA, for example because the latest trust index of the first FESP 602 is below a threshold, the SCP 605 may determine that the first FESP 602 is not trustable by the FESC 604 (644) and may discard the second service notification 632 that was received from the first FESP 602. The SCP 605 may also send a request 634 to the first FESP 502 to cancel the service subscription that was established as a result of the subscription request 610. The SCP 605 may discover another FESP (646), the second FESP 601, which may meet the trust criteria of the FESC 604 and may also support the same target services that the FESC 604 subscribed to using the subscription request 610. If the second FESP 601 meets the trust criteria of the FESC 604 and supports the target services the FESC 604 is interested in, the SCP 605 may send a new service subscription request 636 to the second FESP 601. The second FESP 601 may process the request and send a new service subscription response to the SCP 605 (not shown in FIG. 6). The contents of the new subscription request 636 may be the same as, or similar to, the subscription request 610, and the contents of the new subscription response (not shown in FIG. 6) may be the same as, or similar to, the subscription response 610. In some embodiments, the SCP 605 may send a new subscription notification 638 to the FESC 604 containing the identifier of the second FESP 601 indicating that the FESP has been changed from the first FESP 602 to the second FESP 601. However, in some embodiments, the SCP 605 may not send a new subscription notification the FESC if the SCP wants or needs to keep the new subscription request transparent to the FESC 604.

As mentioned above, ETSI (e.g., ETSI GS PDL-024) provides a permissioned blockchain system architecture where access to the blockchain system is to be permissioned, controlled and/or governed. Permissioned Distributed Ledgers (PDL) as defined by the ETSI ISG on PDL is an example of permissioned blockchain systems.

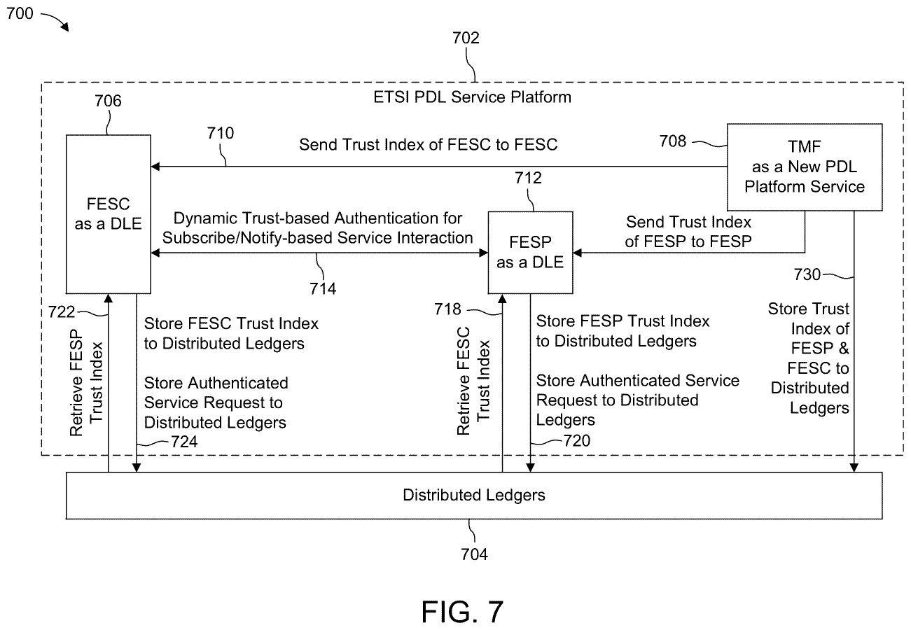

FIG. 7 is a signal diagram 700 showing an example of dynamic trust-based authentication for subscribe/notify-based service interaction using an ETSI PDL Service Platform 702. In the example illustrated in FIG. 7, the FESC 706 is implemented as a Distributed Ledger Enabler (DLE) node such as a DLE client. Alternatively, the FESC may have an embedded DLE or interact with an external DLE. In both cases, the FESC 706 can rely on DLE to interface to the PDL service platform 702. Additionally, in the example illustrated in FIG. 7, the FESP 712 is implemented as a DLE node, such as a DLE peer. Alternatively, the FESP 712 may have an embedded DLE or interact with an external DLE. In both cases, the FESP can also rely on DLE to interface to the PDL service platform 702. Finally, in the example illustrated in FIG. 7, the TMF 708 may be implemented as a new PDL platform service, which can be accessed by the FESC 706 (as a DLE) and the FESP 712 (as a DLE). The TMF 708 may record or store the calculated trust index of FESCs and FESPs, including the TMF's signature, in one or more distributed ledgers 704 (730). Alternatively, the FESC 706 or the FESP 712 may retrieve its trust index from the TMF 708 (722, 718) and then may store its trust index in one or more distributed ledgers 708 (724, 720).

When authenticating a service operation request from the FESC 706, the FESP 712 may retrieve the trust index of the FESC 706 from the one or more distributed ledgers 704 (718) or from the TMF 708 (716). The FESP 712 may subscribe to the one or more distributed ledgers 704 (e.g., via a DLE peer) to receive automatic notifications about the FESC 706's trust index from the one or more distributed ledgers 704. After the service operation request is successfully authenticated using the trust index, the FESP 712 may record or store the request and/or corresponding service results in the one or more distributed ledgers 704 (720). The FESC 706 or the FESP 712 may also retrieve their trust index from one or more distributed ledgers 704.

When authenticating the FESP 712, the FESC 706 may retrieve the trust index of the FESP 706 from the one or more distributed ledgers 704 (722) or from the TMF 708 (710). The FESP 712 may subscribe to the one or more distributed ledgers 704 (e.g., via a DLE peer) to receive automatic notifications about the FESP 712's trust index from the one or more distributed ledgers 704. After the FESP 712 is successfully authenticated using the trust index, the FESC 706 may record or store the request and/or corresponding service results in the one or more distributed ledgers 704 (724).

When a new service notification for the FESC 706 is generated by the FESP 712, the FESP 712 may retrieve the FESC 706's current trust index from the one or more distributed ledgers (704) and may re-authenticate FESC 706 using its current trust index. If the authentication is successful, the FESP 712 may send the new service notification to the FESC 706 (714) and may also record or store this service notification in the one or more distributed ledgers 704 (720).

When the FESC 706 receives a new service notification from the FESP 712 (714), the FESC 706 may retrieve the FESP 712's current trust index from the one or more distributed ledgers (722) and may re-authenticate the FESP 712 using its current trust index. If the authentication is successful, the FESC 706 may accept the received new service notification (714) and may also record or store this service notification to the one or more distributed ledgers 704 (724).

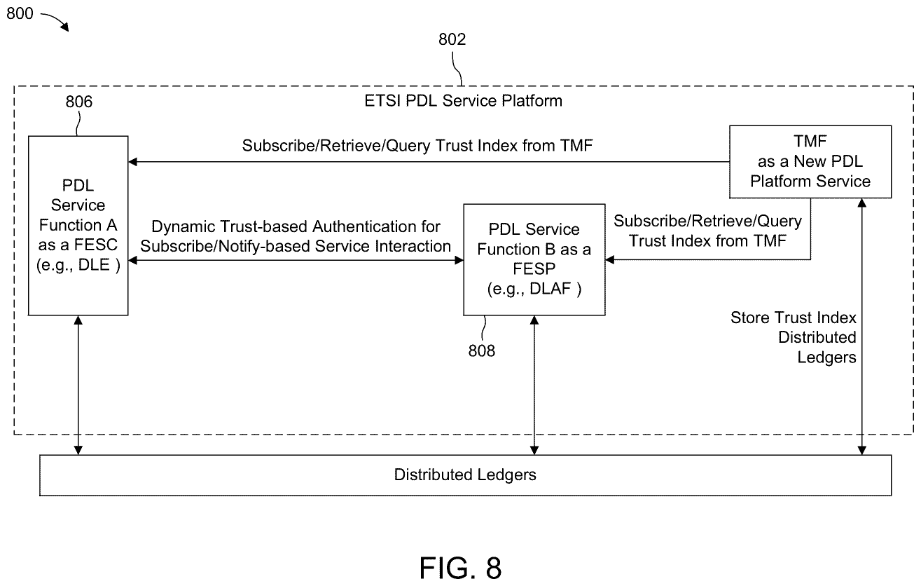

FIG. 8 is a signal diagram 800 showing an example of PDL service interactions based on dynamic trust-based authentication and subscribe/notify using an ETSI PDL Service Platform 802. In the example illustrated in FIG. 8, PDL service functions, such as DLE, DLAF, DLRF, DLDSM, and DLGF, as defined in ETSI GS PDL-024, may leverage the ETSI PDL Service Platform 802, as well as the corresponding functionality illustrated in FIGS. 4, 5 and 6 and described hereinabove, to enhance their interaction with each other. For example, the FESC in FIGS. 4, 5 and 6 may be replaced with a PDL service function A (represented as the “PDL Service Function A as a FESC” 806 in FIG. 8), and the FESP in FIGS. 4, 5 and 6 may be replaced with another PDL service function B (represented as the “PDL Service Function B as a FESP” 808 in FIG. 8).

In the example illustrated in FIG. 8, the PDL service function A as FESC 806 subscribes to services from the PDL service function B as FESP 808. When the PDL service function A 806 subscribes to services provided by the PDL service function B 808, the PDL service function A 806 is the FESC while the PDL service function B 808 is the FESP. Thus, the procedures and corresponding functionality illustrated in FIGS. 4, 5 and 6 and described hereinabove, may be reused. SCP may, thus, be a new PDL service function.

Trust covers and is beyond security. A trust index may be obtained via a trust evaluation process (e.g. conducted by a TMF). A trust index may be an overall metric, which may often be calculated based on an aggregation of one or more trust indicators using certain trust evaluation algorithms. For example, trust indicators may cover various aspects, such as security, privacy, resilience, performance, robustness, scalability, reputation, availability, accuracy, reliability, and consistency. More importantly, the criteria for evaluating trust may also be subjective, for example, based on user/personal experience/preference. For example, given two entities A and B (who need to interact with a third entity C), entities A and B may have different criteria regarding how the trust of entity C should be evaluated. For example, in case entities A and B are service consumers and entity C is a service producer, entity A and entity B may have different trust evaluation criteria regarding how to evaluate entity C's trust for providing various services. For example, entity A may care more about the security, privacy and resilience (as focused trust indicators) of entity C when entity C is providing services to entity A. In comparison, entity B may care more about a different set of trust indicators (such as availability, or residency) of entity C when entity C is providing services to entity B. Therefore, the embodiments described herein may have the following generalizations related to trust index. The following generalizations may be applicable to all the proposed procedures and embodiments in this disclosure, for example, all the messaging between an entity and a TMF).

In a first generalization related to trust index generation, it is proposed that: when any requesting entity (e.g. entity A, which may be an FESP, or an FESC, as defined in herein) needs to contact a TMF (e.g. by sending a request to the TMF) to inquire about a trust index of another target entity (e.g., entity C) or initiating a trust evaluation on the target entity, the TMF not only may provide the trust index of the target entity (as described herein) and return the trust index to the requesting entity (e.g. entity A), but also may return the associated explanatory information in the response. An associated explanatory information may be when and how the trust index was generated and the applicable scope of the trust index. For example, the trust index may have been generated by a TMF ten seconds ago, which reflects the latest trust index of the target entity An associated explanatory information may be how the trust index was generated. For example, this parameter may indicate the next level of information regarding what kinds of trust evaluation criteria have been adopted by the TMF to generate this trust index. This parameter may indicate what kinds of data were collected for trust evaluation and where the data were stored, what kinds of trust indicators were used, what kinds of algorithms were adopted for calculating trust indicators and/or the trust index, what kinds of collected data were used as inputs for the adopted algorithms during the trust evaluation in order to calculate the focused trust indicators and/or the overall trust index, and/or what kinds of parameter values were set during the calculation of trust indicators or a trust index.

The TMF may be pre-configured with a popular or standard suite of trust evaluation criteria so that the TMF may conduct a standard or popular trust evaluation, which may be appropriate or desired for most requesting entities. It is possible that a target entity (e.g., entity C acting as an FESP) may provide different services, but the target entity may have different levels of trust when delivering those different services. For example, one service (e.g., Service X) provided by the target entity may be related to computing operations, while another service (e.g., Service Y) provided by the target entity may be related to communication operations. Therefore, it is possible that the target entity may have a high trust index for providing Service X, and at the same time, an FESP may have a low trust index for providing Service Y. Overall, in the first generalization, anytime when the TMF needs to send a trust index to a receiver (i.e., the entity A that has sent a request to the TMF for a trust index inquiry or a trust evaluation), the above new information elements may also be attached, along with the returned trust index value.

A second generalization related to trust index generation is that, when any requesting entity (such as entity A) sends a request to a TMF to inquire about the trust index of a target entity (such as entity C), the request may further include parameters that may enable customized trust evaluation by describing how the requesting entity (e.g., entity A) prefers the TMF to conduct trust evaluation on the target entity or how the trust index should be calculated. For example, in addition to whose trust index is being inquired about (e.g., entity C), the following new information elements related to customized trust evaluation criteria may also be included in the request sent from entity A to the TMF: how the trust of the target entity should be evaluated (e.g., what kinds of specific trust evaluation criteria should be adopted by the TMF to generate the trust index) and/or the applicable scope of the trust index. Examples of information about how the trust of the target entity should be evaluated may include what kinds of trust indicators should be used and what kinds of algorithms should be adopted for calculating trust indicators and/or the trust index. Alternatively, the TMF may be pre-provisioned with different sets of trust evaluation criteria (each may be identified by a trust evaluation criteria identifier). If that is the case, entity A may directly indicate the identifier of the preferred trust evaluation criteria when it sends the trust index inquiry request to the TMF. By receiving this parameter, the TMF will adopt the corresponding trust evaluation criteria preferred by the entity A when the TMF conducts trust evaluation on the target entity (i.e., entity C) in order to generate the trust index of the target entity.

Regarding the applicable scope of the trust index, it is possible that the target entity (such as entity C) may provide different services, but the target entity may have different levels of trust when delivering those different services. For example, one service (e.g., Service X) provided by the target entity may be related to computing operations, while another service (e.g. Service Y) provided by the target entity may be related to communication operations. Therefore, this parameter is to indicate that entity A intends to inquiry the trust index of the target entity (i.e., entity C) regarding which services. For example, entity A may only want to know the trust of the target entity for providing a specific Service X. For another example, entity A may want to know the trust of the target entity for providing a set of specific services (e.g., Service X, Service Y, etc.) or even all of the services provided by the target entity. Once the TMF receives this parameter, it may allow the TMF to determine which data should be collected in order to calculate the needed trust index.

The TMF may conduct the customized trust evaluation based on the above parameters sent from entity A. Once a trust index is generated by the TMF, the trust index will be returned to entity A. Further, similar to the first generalization related to trust index generation, when retuning the trust index to entity A, the TMF not only can provide the trust index value of the target entity (e.g., a numerical value or a rank) but also may return a set of explanatory information, which may be the same as the parameters listed in the first generalization, such as when the trust index was generated, how the trust index was generated (e.g. the adopted trust evaluation criteria, etc.), the applicable scope of the trust index, etc.

The embodiments described herein may involve steps or actions related to a requesting entity needing to interact with a TMF, such as by sending a request to a TMF to inquire about the trust index of a target entity and receiving a response from the TMF with requested trust index attached. It is proposed that such an interaction can be further generalized to obtaining the trust index of a target entity from the TMF. In other words, depending on how the TMF is implemented, obtaining the trust index of a target entity may be realized in different ways. For example, the requesting entity may communicate with the TMF via an intermediated medium, such as a distributed ledger. Also, the TMF may be implemented in different ways. For example, the TMF may be implemented as a native 3GPP function, such as a new Network Function (NF) in the core network or a new function inside the access network of the 3GPP system, or may be implemented as an enhanced feature of an existing NF in a 3GPP cellular system, such as 5G network data analytics function (NWDAF) and/or the Security Function deployed by the MNO. Alternatively, the TMF may be implemented as a new ETSI PDL platform service, or the TMF may be implemented as a smart contract deployed in a distributed ledger system. If the TMF is implemented as a smart contract deployed in a distributed ledger system, the request/response will be embodied as distributed ledger transactions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A function entity service producer (FESP) comprising:
a processor; and
a transceiver,
wherein the processor and the transceiver are configured to:
receive a subscription request message from a function entity service consumer (FESC), wherein the subscription request message comprises at least an indication of services the FESC is requesting and an indication of a condition that the service function is to apply when determining whether to send a service notification pursuant to the subscription,
receive a trust index of the FESC from a trust management function (TMF), wherein the trust index is at least one of a trust index of the FESC or a trust index of a user of the FESC,
determine to authenticate the subscription request based on the trust index being greater than a threshold,
receive an updated trust index of the FESC from the TMF based at least in part on the condition being met, and
send the service notification to the FESC based at least in part on the updated trust index of the FESC being greater than the threshold.

2. The FESP of claim 1, wherein the trust index is a metric that indicates a level of trustworthiness and is based on a trust evaluation of one or more trust indicators.

3. The FESP of claim 2, wherein the trust indicators comprise factors related to at least one of security, privacy, resilience, performance, robustness, scalability, reputation, availability, accuracy, reliability, or consistency.

4. The FESP of claim 1, wherein the processor and the transceiver are further configured to determine to not authenticate the subscription request based on the trust index being less than the threshold and to send a response message to the FESC indicating the subscription request cannot be accepted.

5. The FESP of claim 1, wherein the processor and the transceiver are further configured to send a subscription update or cancellation request message to the FESC to adjust or cancel the subscription based on the updated trust index of the FESC being less than the threshold.

6. The FESP of claim 1, wherein the processor and the transceiver are further configured to subscribe to the TMF to receive the trust index and updated trust indices of the FESC over a duration.

7. The FESP of claim 1, wherein the processor and the transceiver are further configured to send a request for the updated trust index, to the other node, in response to the condition being met.

8. The FESP of claim 1, wherein the processor and the transceiver are further configured to send a response to the FESC indicating successful subscription based on the transceiver and the processor determining to authenticate the subscription request.

9. The FESP of claim 1, wherein the processor and the transceiver are further configured to store the updated trust index of the FESC to a least one permissioned distributed ledger (PDL).

10. The FESP of claim 9, wherein the processor and the transceiver are further configured to retrieve trust indices from the at least one PDL.

11. A method, implemented in a function entity service producer (FESP), the method comprising:
receiving a subscription request message from a function entity service consumer (FESC), wherein the subscription request message comprises at least an indication of services the FESC is requesting and an indication of a condition that the service function is to apply when determining whether to send a service notification pursuant to the subscription;
receiving a trust index of the FESC from a trust management function (TMF), wherein the trust index is at least one of a trust index of the FESC or a trust index of a user of the FESC,
determining to authenticate the subscription request based on the trust index being greater than a threshold;
receiving an updated trust index of the FESC from the TMF based at least in part on the condition being met; and
sending the service notification to the FESC based at least in part on the updated trust index of the FESC being greater than the threshold.

12. The method of claim 11, wherein the trust index is a metric that indicates a level of trustworthiness and is based on a trust evaluation of one or more trust indicators.

13. The method of claim 12, wherein the trust indicators comprise factors related to at least one of security, privacy, resilience, performance, robustness, scalability, reputation, availability, accuracy, reliability, or consistency.

14. The method of claim 11, further comprising determining to not authenticate the subscription request based on the trust index being less than the threshold and sending a response message to the FESC indicating the subscription request cannot be accepted.

15. The method of claim 11, further comprising sending a subscription update or cancellation request message to the FESC to adjust or cancel the subscription based on the updated trust index of the FESC being less than the threshold.

16. The method of claim 11, further comprising subscribing to the TMF to receive the trust index and updated trust indices of the FESC over a duration.

17. The method of claim 11, further comprising sending a request for the updated trust index, to the other node, in response to the condition being met.

18. The method of claim 11, further comprising sending a response to the FESC indicating successful subscription based on the transceiver and the processor determining to authenticate the subscription request.

19. The method of claim 11, further comprising storing the updated trust index of the FESC to a least one permissioned distributed ledger (PDL).

20. The method of claim 19, further comprising retrieving trust indices from the at least one PDL.

21. A function entity service consumer (FESC) comprising:
a processor; and
a transceiver,
wherein the processor and the transceiver are configured to:
send a subscription request message to a function entity service producer (FESP), wherein the subscription request message comprises at least an indication of services the FESC is requesting and an indication of a condition that the service function is to apply when determining whether to send a service notification pursuant to the subscription,
receive an authentication notification from the FESP based at least on a trust index of at least one of the FESC or a user of the FESC being above a threshold, and
receive a subscription update or cancellation request message from the FESP to adjust or cancel the subscription based on an updated trust index of the FESC being less than the threshold when the condition is met.

22. The FESC of claim 21, wherein the trust index is a metric that indicates a level of trustworthiness and is based on a trust evaluation of one or more trust indicators.

23. The FESC of claim 22, wherein the trust indicators comprise factors related to at least one of security, privacy, resilience, performance, robustness, scalability, reputation, availability, accuracy, reliability, or consistency.

24. The FESC of claim 21, wherein the processor and the transceiver are further configured to receive the service notification from the FESP when the condition is met and the updated trust index of the FESC is greater than the threshold when the condition is met.

25. The FESC of claim 21, wherein the processor and the transceiver are further configured to receive a denial notification from the FESP based on the trust index of the at least one of the FESC or the user of the FESC being below the threshold.
